(19) United States
(12) Patent Application Publication
(10) Pub. No.: US 2016/0128376 A1
(43) Pub. Date: May 12, 2016

(54) FOOD PRODUCT DRYING SYSTEM

(71) Applicant: Benjamin G. Casper, (US)

(72) Inventors: Benjamin G. Casper, Basin City, WA (US); Kim Haws, Richland, WA (US)

(21) Appl. No.: 14/934,984

(22) Filed: Nov. 6, 2015

Related U.S. Application Data
(60) Provisional application No. 62/076,454, filed on Nov. 6, 2014.

(51) Int. Cl. A23L 3/40; F26B 5/00

(52) U.S. Cl. CPC A23L 3/40; F26B 5/00; A23V 2002/00

(57) ABSTRACT

In certain embodiments, a system comprises a first air tunnel system configured to be coupled to a wall of a food storage bin, the first air tunnel system comprising one or more air tunnels. Each air tunnel of the first air tunnel system comprises a first end operable to receive an airflow from a first fan system comprising at least one fan, a body operable to direct the airflow from the first end of the air tunnel towards a second end of the air tunnel, and at least one aperture formed in the body between the first end and the second end, the at least one aperture operable to direct the airflow away from the body of the air tunnel.

### CROSS REFERENCE TO RELATED APPLICATION

This application claims the benefit of priority under 35 U.S.C. §119 of U.S. Provisional Patent Application No. 62/076,454 filed Nov. 6, 2014 and entitled FOOD PRODUCT DRYING SYSTEM, which is incorporated herein by reference in its entirety.

### TECHNICAL FIELD

This invention relates generally to food product storage and more particularly to a food product drying system.

### BACKGROUND OF THE INVENTION

In certain situations, it is desirable to reduce the water content of a food product stored within a structure. For example, a freshly harvested food product, such as corn or soybeans may be placed in a food storage bin for storage before shipment to a feedlot or other location. In some situations, the food product may be stored in the food storage bin for several months.

During this time, excessive moisture in the food product may promote heat, insect infestation, and bacterial growth, causing the food product to decompose or degrade, rendering it unsuitable for consumption or other use. Accordingly, the need exists for effective and efficient systems for reducing the moisture content of food products stored within a structure. Systems for reducing the moisture content of food products within a structure, however, have proven inadequate in various respects.

### SUMMARY OF THE INVENTION

According to embodiments of the present disclosure, disadvantages and problems associated with previous systems may be reduced or eliminated.

In certain embodiments, a system comprises a first air tunnel system configured to be coupled to a wall of a food storage bin. The first air tunnel system comprises one or more air tunnels that each include a first end operable to receive an airflow from a first fan system comprising at least one fan. Each air tunnel also includes a body operable to direct the airflow from the first end of the air tunnel towards a second end of the air tunnel. Each air tunnel also includes at least one aperture formed in the body between the first end and the second end that is operable to direct the airflow away from the body of the air tunnel.

Certain embodiments of the present disclosure may provide various technical advantages. For example, certain embodiments may enable an air tunnel system to dry food product located above the air tunnel system and below the air tunnel system. Certain embodiments may enable the drying of food product using relatively inexpensive fans. Certain embodiments may enable the drying of food products using a relatively small amount of energy.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example system for drying a food product stored in a food storage bin, according to certain embodiments of the present disclosure;

FIG. 2 illustrates an example air tunnel, according to certain embodiments of the present disclosure;

FIG. 3 illustrates an example venting tunnel, example air tunnel, and example duct system, according to certain embodiments of the present disclosure;

FIG. 4 illustrates the venting tunnel and air tunnel of FIG. 3 in the presence of food product having a level higher than the air tunnel, according to certain embodiments of the present disclosure;

FIG. 5 illustrates an overhead view of an example air tunnel system, according to certain embodiments of the present disclosure;

FIG. 6 illustrates another example system for drying a food product stored in a food storage bin, according to certain embodiments of the present disclosure;

FIG. 7 illustrates an example air heating system, according to certain embodiments of the present disclosure;

FIG. 8 illustrates another example air heating system, according to certain embodiments of the present disclosure;

FIG. 9 illustrates a method for forming a food product drying system, according to certain embodiments of the present disclosure;

FIG. 10 illustrates an example system for drying a food product stored in a food storage bin, according to certain embodiments of the present disclosure;

FIG. 11 illustrates an example air tunnel, according to certain embodiments of the present disclosure;

FIG. 12 illustrates an example venting tunnel, example air tunnel, and example duct system, according to certain embodiments of the present disclosure;

FIG. 13 illustrates an overhead view of an example air tunnel system, according to certain embodiments of the present disclosure; and

FIG. 14 illustrates another example system for drying a food product stored in a food storage bin, according to certain embodiments of the present disclosure.

FIG. 15 illustrates another example system for drying a food product stored in a food storage bin, according to certain embodiments of the present disclosure.

FIG. 16 illustrates an embodiment including multiple segments of an air tunnel, according to certain embodiments of the present disclosure.

FIG. 17 illustrates an example sliding joint that may be used with air tunnels or venting tunnels, according to certain embodiments of the present disclosure.

FIG. 18 illustrates a portion of an example air tunnel and example air tunnels attached thereto, according to certain embodiments of the present disclosure.

FIG. 19 illustrates a portion of an example air tunnel, according to certain embodiments of the present disclosure.

FIG. 20 illustrates another example system for drying a food product stored in a food storage bin, according to certain embodiments of the present disclosure.

FIG. 21 illustrates components of the example system of FIG. 20.

FIG. 22 illustrates components of the example system of FIG. 20.

### DETAILED DESCRIPTION OF THE DRAWINGS

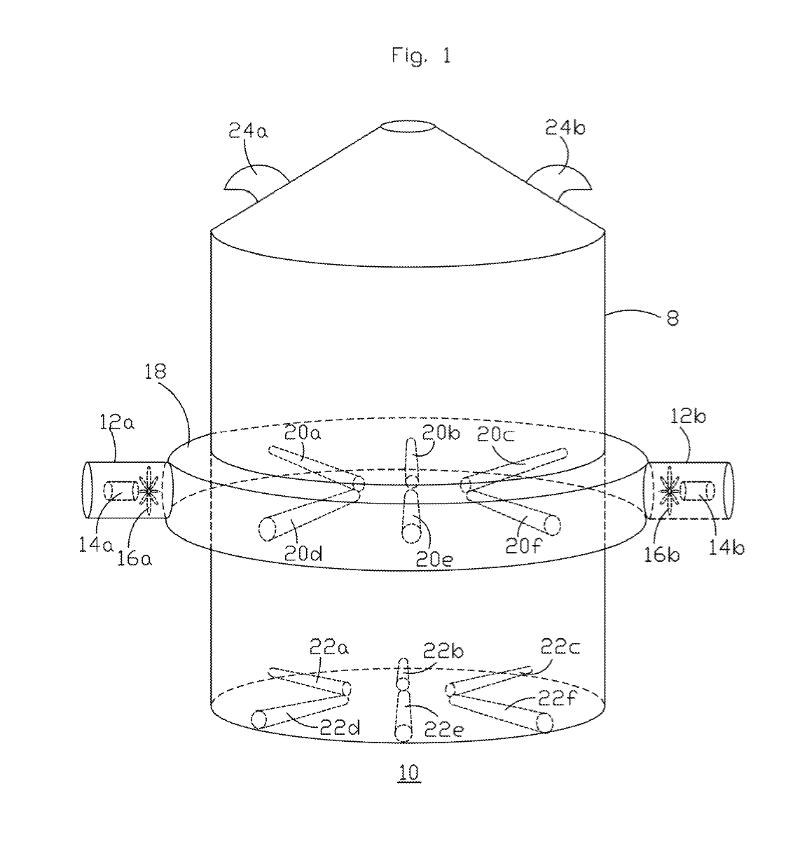

FIG. 1 illustrates an example system 10 for drying a food product stored in a food storage bin 8, according to certain embodiments of the present disclosure. System 10 includes a fan system comprising fan units 12a and 12b, duct system 18, an air tunnel system comprising air tunnels 20a-f, a first venting system including venting tunnels 22a-22f, and a second venting system including venting tunnels 24a and 24b.

A hydrated food product may be placed in food storage bin 8. A hydrated food product may refer to any bioproduct that includes moisture content that may be reduced by aeration, such as corn and soybeans. Food storage bin 8 may be filled to any suitable level with the food product. The one or more fan units 12 are operable to draw air from the outside of the food storage bin 8 and propel the air into the air tunnels 20. At least a portion of each air tunnel 20 is located inside of the food storage bin 8. The air from the fan units passes through the air tunnels 20 and flows out of one or more apertures in the air tunnels 20 and throughout the food storage bin 8. The air exiting air tunnels 20 may flow in horizontal or vertical directions (or a combination thereof). A portion of the air may travel upwards from the air tunnels 20, through the food product, and out of venting tunnels 24a and 24b. Another portion of the air may travel downwards from air tunnels 20, through the food product, and out of venting tunnels 22a-f. As the air travels through the food product, it may absorb moisture from the food product and carry the moisture outside of the food storage bin 8. In this manner, system 10 is operable to dry the food product placed in the food storage bin 8. Certain embodiments of the present disclosure avoid various drawbacks associated with conventional systems for drying food products. For example, various embodiments do not use combustion to heat the air that is blown into the food storage bin 8 and thus use less energy than batch or continuous flow dryers that heat air with propane or other energy source before fan-forcing the heated air through the food product. Such embodiments may also avoid degradation risks associated with the increased temperature of the food product.

As another example, certain embodiments of the present disclosure may enable the use of smaller fans that consume less power than fans of conventional systems. For example, in many conventional natural air drying systems (i.e., systems that dry food products without artificially heating the air before blowing it into the food product), high power fans located at the base of a food storage bin may push air upwards through a perforated floor of the food storage bin. The air then travels through the entire mass of food product and escapes out of vents located at the roof of the food storage bin. However, such systems require expensive high powered fans and large amounts of energy. Moreover, such systems may be limited in height as to the amount of food product that may be placed in the food storage bin for drying. As the depth of the food product increases, the horsepower requirement of the fans used to dry the entire mass of food product increases exponentially. Various embodiments of the present disclosure increase the amount of food product that may be dried by a fan system by directing the air provided by the fan system in an upward and a downward direction from an air tunnel system. This enables the use of relatively inexpensive fans that consume a relatively small amount of energy.

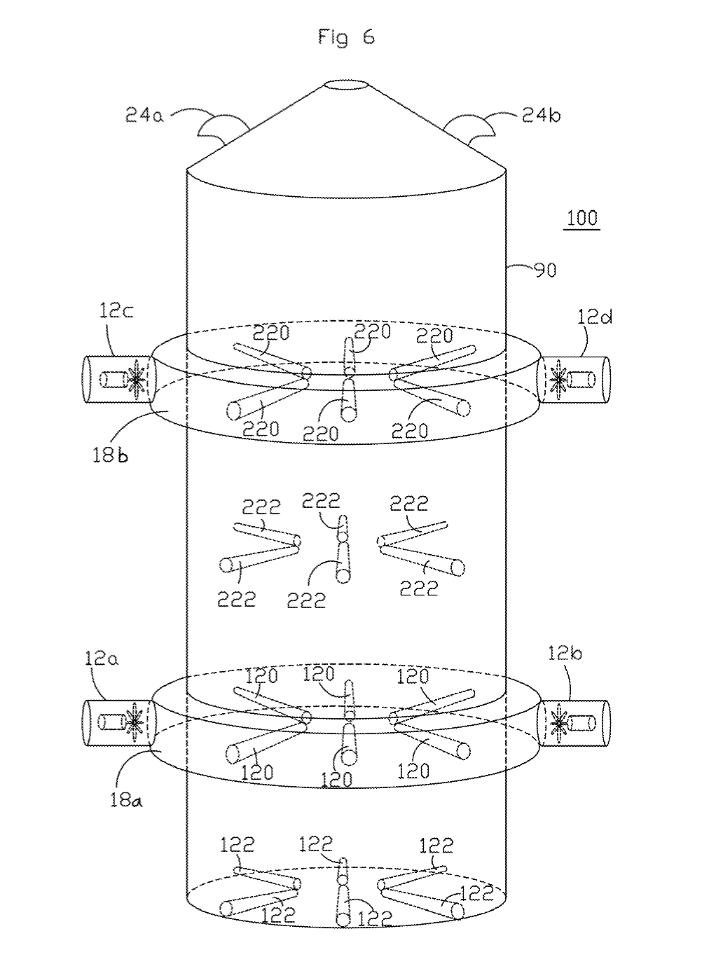

In particular embodiments, distinct air tunnel systems may be placed at different levels of food storage bin 8. Such embodiments may enable the drying of masses of food products having heights that exceed that which may be dried practically by conventional drying systems. One such embodiment will be discussed in further detail in connection with FIG. 6.

Food storage bin 8 may have any suitable shape. In the embodiment depicted, the food storage bin includes a conical roof and a cylindrical main portion having a circular cross section in the horizontal direction. In other embodiments, food storage bin 8 may have other suitable shapes, including a structure with a rectangular or other polygonal cross section in the horizontal direction. Food storage bin 8 may be made of any suitable materials, such as steel, aluminum or other metal, concrete, wood, or plastic. In particular embodiments, the walls of food storage bin 8 are corrugated. The floor of food storage bin 8 may be made of cement or other suitable material. In particular embodiments, food storage bin 8 may include an auger system underneath the floor to facilitate emptying of the food storage bin 8. In particular embodiments, the floor of food storage bin may be a false floor or partial false floor including perforations to facilitate aeration in the food storage bin.

System 10 may include one or more fan systems. Each fan system includes at least one fan unit 12 and may include any suitable number of fan units. A fan system may refer to one or more fans that supply air for a particular air tunnel system. In particular embodiments, a fan system may comprise multiple fan units 12 located at the same height (or substantially similar heights). For example, in the embodiment depicted, a single fan system includes two fan units 12a and 12b coupled to food storage bin 8 at the same elevation. Each fan unit 12 may include any suitable components operable to draw fresh air from outside of food storage bin 8 and blow the air into one or more of the air tunnels 20. In the embodiment depicted, each fan unit 12 includes an electric motor 14 and a blade set 16 that is operable to spin when acted upon by the motor. Other embodiments may include an engine or other suitable component in place of a motor. A fan unit 12 may include any suitable type of fan, such as an axial fan, a centrifugal fan, a crossflow fan, or other suitable fan. In particular embodiments, relatively inexpensive and efficient axial fans may be used in fan unit 12 since the air pressure requirement is reduced due to the capability of the air tunnels 20 to disperse the air in both an upward and downward direction. This may greatly reduce the vertical air travel distance from the air source (air tunnel 20) to exhaust (venting tunnels 22 or 24). In particular embodiments, system 10 may omit fans located at the base of the food storage bin as used in conventional natural air drying.

A fan unit 12 may blow air directly into an air tunnel 20 or the air may travel through one or more intermediate components (e.g., duct system 18) before reaching an air tunnel 20. In particular embodiments, a fan unit 12 may provide an airflow for a single air tunnel 20 (thus each air tunnel 20 may be coupled to its own fan unit 12). In other embodiments, a fan unit 12 may provide air for multiple air tunnels 20. For example, in the embodiment depicted, fan units 12a and 12b each provide air to duct system 18 which provides a passage for air to flow to any of the air tunnels 20a-f. In other embodiments, a fan unit 12 may supply air to a set of air tunnels 20 (e.g., via a first duct system) and a different fan unit may supply air to a different set of air tunnels 20 (e.g., via a second duct system).

In the embodiment depicted, the fan system is located at the same vertical level as the air tunnel system to which it supplies air. In other embodiments, the fan system may be located at a different elevation from the corresponding air tunnel system (e.g., the fan system may be located at or near ground level) and a duct system may transport air from the fan units of the fan system to the air tunnels of the air tunnel system.

Duct system 18 serves as a passageway to transport air from a fan system to an air tunnel system. A duct system 18 may carry air in any suitable direction, including horizontally, vertically, or a combination thereof. Duct system 18 may be disposed in any suitable location, such as on the outside or inside of the food storage bin 8. In the embodiment depicted, duct system 18 encompasses the outer wall of the food storage bin 8 and forms a ring around food storage bin 8. In other embodiments, duct system 18 may have other suitable shapes. In particular embodiments, a portion of an outer or inner wall of food storage bin 8 is utilized as one of the sides of the duct system 18. Accordingly, when a food storage bin 8 is retrofit according to one or more embodiments of the present application, duct system 18 (or a portion thereof) may be secured to an existing wall of food storage bin 8. The duct system 18 may comprise any suitable material, such as plastic, aluminum, other metal, or other material. In various embodiments, duct system 18 comprises a galvanized metal suitable to withstand prolonged exposure to moisture.

System 10 also includes at least one air tunnel system. In the embodiment depicted, system 10 depicts an air tunnel system comprising air tunnels 20a-f. An air tunnel system may refer to a single air tunnel 20 or a plurality of air tunnels 20 that are disposed at the same height (or substantially similar heights). Each air tunnel 20 may be coupled to a wall of food storage bin 8. An air tunnel 20 may be coupled directly to the wall or indirectly through another component, such as a portion of duct system 18, a mounting plate, or other suitable component. In the embodiment depicted, air tunnels 20 are coupled to the inside of a wall of food storage bin 8 and extend inward towards a central vertical axis of food storage bin 8. In alternative embodiments, air tunnels 20 may be coupled to the outside of food storage bin 8.

Food storage bin 8 may include an aperture in a wall at the location of each air tunnel 20 to allow an airflow from a fan unit 12 or duct system 18 to travel from the outside of food storage bin 8 into an air tunnel 20 located (at least partially) inside of food storage bin 8. In particular embodiments, air tunnels 20 are attached to the inside of the wall of food storage bin 8 and encompass or are encompassed by the corresponding apertures in the wall of food storage bin 8. When a food storage bin 8 is retrofit to include one or more air tunnels, the apertures may be cut or otherwise formed in a wall of food storage bin. When a food storage bin 8 is built in anticipation of having air tunnels 20, the wall of food storage bin 8 may be manufactured with the aperture or may be manufactured and the aperture may then be cut from the material of the wall or formed in another suitable manner. The aperture may be formed in the shape of the cross section of the corresponding air tunnel 20 or other suitable shape. For example, the aperture may be a circle for a cylindrical air tunnel or a rectangle for a rectangular parallelepiped air tunnel.

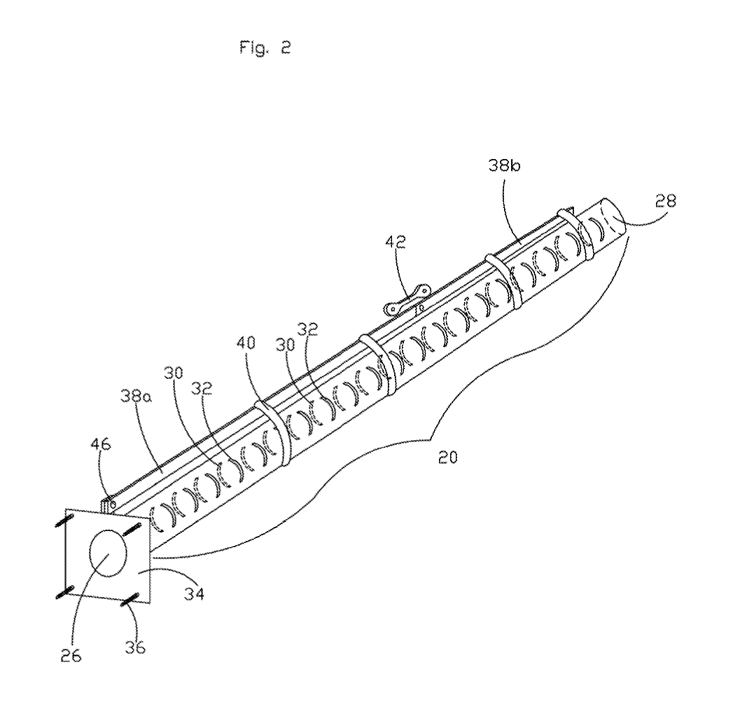

Each air tunnel 20 is operable to receive airflow from at least one fan unit 12 of a fan system. In particular embodiments, each air tunnel 20 may be coupled to and receive airflow from a distinct fan unit 12 (in some of these embodiments duct system 18 may be omitted if the fan units are mounted proximate their corresponding air tunnels). In other embodiments, a single fan unit 12 may be coupled to and provide airflow to multiple air tunnels 20 via a duct system 18. In yet other embodiments, multiple fan units 12 may be coupled to and provide airflow to multiple air tunnels 20 via a duct system 18 (as shown in FIG. 1). Air tunnels 20 will be described in further detail in connection with FIGS. 2-5. In other embodiments, one or more fan units 12 may be coupled to and provide airflow to one or more air duct systems 18 via one or more vertical duct systems.

System 10 also includes at least one venting tunnel system. A venting tunnel system may refer to a single venting tunnel or a plurality of venting tunnels that are disposed at the same height (or substantially similar heights). In the embodiment depicted, system 10 depicts a first venting tunnel system comprising venting tunnels 22a-f and a second venting tunnel system comprising venting tunnels 24a and 24b. The first venting tunnel system is located below the air tunnel system of system 10 and the second venting tunnel system is located above the air tunnel system.

Each venting tunnel may have any suitable shape. In particular embodiments, a venting tunnel may be an aperture in a side or roof of food storage bin. In other embodiments, a venting tunnel may include a passage connected to an aperture in a side or roof of food storage bin 8 such that air from within food storage bin 8 may pass through the aperture to the outside of food storage bin 8. The passage may be located within food storage bin 8 or outside of food storage bin. In particular embodiments, a venting tunnel may include a passage within food storage bin 8, an aperture in the wall or roof of food storage bin, and a passage outside of food storage bin 8. In the embodiment depicted, venting tunnels 22 each include an aperture in the wall of food storage bin 8 and a passage located inside of food storage bin 8, while venting tunnels 24 each include an aperture in the roof of food storage bin 8 and a passage located outside of food storage bin 8. At least a portion of the venting tunnel may be shaped so as to prevent rain, snow, or other moisture from entering food storage bin 8 through the venting tunnel. For example, an open end of the venting tunnel disposed outside of food storage bin 8 may face downward (as is shown by venting tunnels 24a and 24b).

The first venting tunnel system (comprising venting tunnels 22a-f) operates to create an area near the bottom of the food storage bin 8 having an atmospheric pressure lower than the atmospheric pressure around the air tunnel system. Thus, the first venting tunnel system may create a vacuum to draw airflow downward from the air tunnel system. Thus, at least a portion of the air released from air tunnels 20a-20f may travel down through food storage bin 8 (and food products placed therein), into venting tunnels 22a-f, and out of the food storage bin. Likewise, the second venting tunnel system (comprising venting tunnels 24a and 24b) operates to create an area near the top of the food storage bin 8 having an atmospheric pressure lower than the atmospheric pressure around the air tunnel system. Thus, the second venting tunnel system may create a vacuum to draw airflow upward from the air tunnel system. Thus, at least a portion of the air released from air tunnels 20a-f may travel up through food storage bin 8 (and food products placed therein), into venting tunnels 24a and 24b, and out of the food storage bin.

The first and second venting tunnel systems may be displaced from the air tunnel system at vertical distances that are small enough to allow low power fan units to provide an adequate amount of air to dry the food product placed in food storage bin 8. In particular embodiments, the vertical distance between an air tunnel system and a venting tunnel system is between 8 and 12 feet. In such embodiments, low power, energy efficient axial fans may be used for fan units 12 to dry food products placed in food storage bin 8.

Each venting tunnel 22 may be coupled to a wall of food storage bin 8. A venting tunnel 22 may be coupled directly to the wall or indirectly through another component, such as a mounting plate or other suitable component. In the embodiment depicted, venting tunnels 22 are coupled to the inside of a wall of food storage bin 8 and extend inward towards a central vertical axis of food storage bin 8. In alternative embodiments, venting tunnels 22 may be coupled to the outside of food storage bin 8.

Each venting tunnel 24 may be coupled to a wall or the roof of food storage bin 8. A venting tunnel 24 may be coupled directly to the wall or roof or indirectly through another component, such as a mounting plate or other suitable component. In the embodiment depicted, venting tunnels 24 are coupled to the outside of a roof of food storage bin 8, though they could alternatively be coupled to the inside of food storage bin 8. As an alternative, venting tunnels 22 or 24 may be supported from the roof or floor of food storage bin 8.

Food storage bin 8 may include an aperture in a wall or roof at the location of each venting tunnel 22 or 24 to allow airflow received by the venting tunnel from one or more air tunnels 20 to be vented outside of food storage bin 8. In particular embodiments, a venting tunnel 22 or 24 is attached to the inside or outside of the wall or roof of food storage bin 8 and encompasses or is encompassed by its corresponding aperture. When a food storage bin 8 is retrofit to include one or more venting tunnels, the apertures corresponding to these venting tunnels may be cut or otherwise formed in a wall or roof of food storage bin. When a food storage bin 8 is built in anticipation of having venting tunnels 22 or 24, the wall or roof of food storage bin 8 may be manufactured with the apertures or may be manufactured and the apertures may then be cut from the material of the wall or roof or formed in another suitable manner. The apertures may be formed in the shape of the cross section of the corresponding venting tunnels 22 or 24 or other suitable shape. For example, an aperture may be a circle for a cylindrical venting tunnel or a rectangle for a rectangular parallelepiped venting tunnel.

In a particular embodiment, the venting tunnels 24a and 24b disposed in a roof of food storage bin 8 do not extend inside of food storage bin as these venting tunnels are located near an open space that does not generally include food product and thus air traveling upward from the air tunnel system may easily exit food storage bin 8 via the venting tunnels 24a and 24b. Conversely, the venting tunnels 22a-22f may be placed in areas of food storage bin that include the food product, thus impeding air flow out of the food storage bin 8. However, venting tunnels 22a-22f may each include portions that extend inside of food storage bin 8. These portions may each include a plurality of apertures, thus increasing the area of the venting tunnels 22 that are available to collect air from the air tunnel system, thus increasing the ability of the first venting system to vent the air to the outside of food storage bin 8.

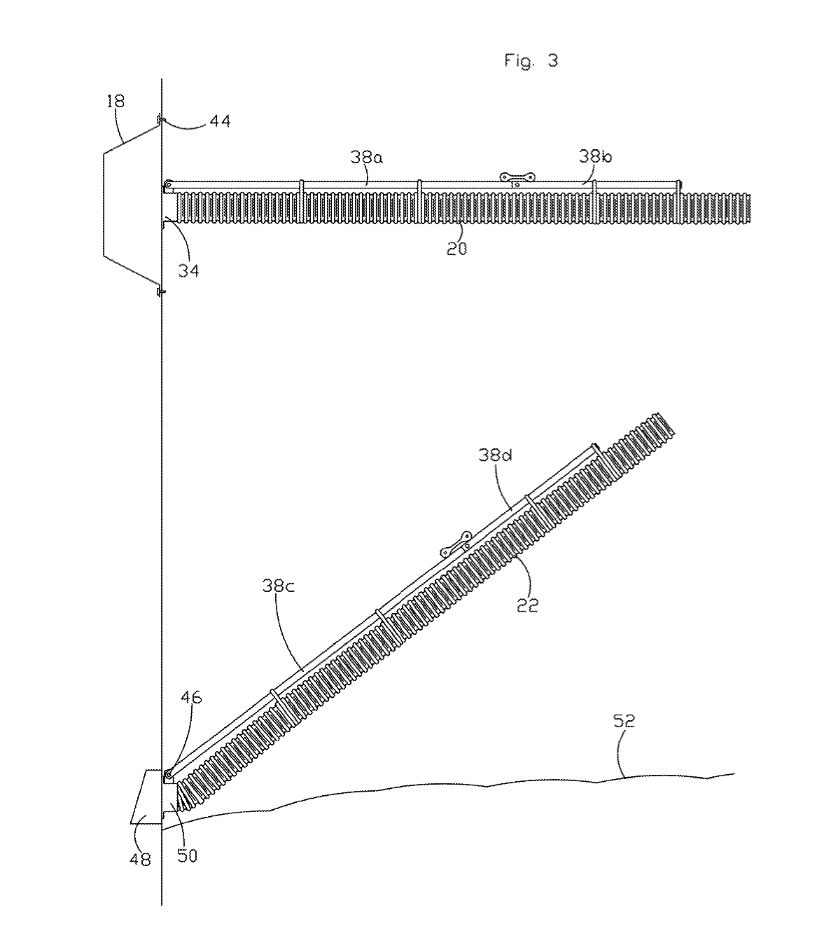

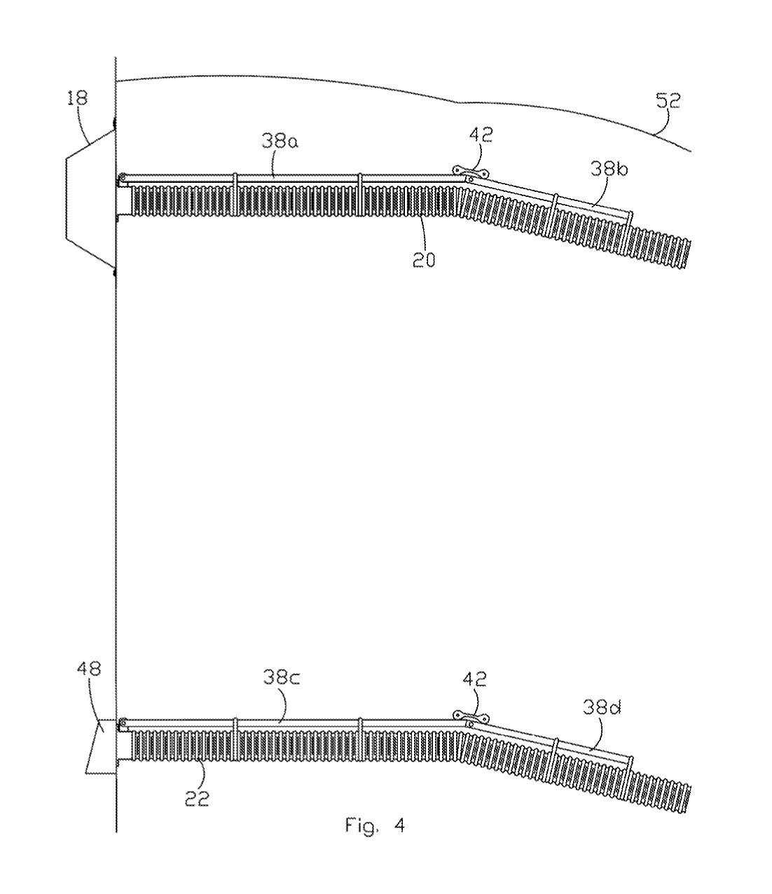

In particular embodiments, a venting tunnel 22 or 24 may have any suitable characteristics of an air tunnel 20 described herein. For example, at least a portion of the venting tunnel may have the same shape as at least a portion of an air tunnel 20 or may comprise the same material as the air tunnel 20. Venting tunnels 22 will be described in further detail in connection with FIGS. 3 and 4.

Although a particular implementation of system 10 is illustrated and primarily described, the present disclosure contemplates any suitable implementation of system 10, according to particular needs. For example, any suitable number of fan systems, air tunnel systems, or venting systems may be used. As another example, any suitable number of fan units, air tunnels, or venting tunnels may be present in system 10. As just one example, system 10 may include four or eight air tunnels in an air tunnel system or four or eight venting tunnels in a venting tunnel system. Moreover, although various components of system 10 have been depicted as being located at particular positions, the present disclosure contemplates those components being positioned at any suitable location, according to particular needs.

FIG. 2 illustrates an example air tunnel 20, according to certain embodiments of the present disclosure. Air tunnel 20 includes at least one aperture. In particular embodiments, the at least one aperture is located along the body of air tunnel 20 (e.g., on a side or portion that extends horizontally when air tunnel 20 is coupled to food storage bin 8 as opposed to one of the ends of air tunnel 20). An aperture may allow air traveling from a first end 26 of the air tunnel to a second end 28 to escape from the air tunnel. The apertures of air tunnel 20 may be any suitable shape. For example, the apertures may be slits, round holes, rectangular holes, or other holes having different shapes. In particular embodiments, an aperture may be a channel formed along the body (or a portion thereof) of air tunnel 20. Air tunnel 20 may include a plurality of apertures 30 on a first side or portion of the air tunnel and another plurality of apertures 32 on a second side or portion of the air tunnel that is separate from the first side. In the embodiment depicted, the first portion including apertures 30 is opposite the second portion including apertures 32. In the embodiment depicted, apertures 30 and 32 are vertical slits cut into air tunnel 20. One or more of the apertures or the second end 28 may have a screen or other structure placed over them that allows air to pass through but blocks the food product from entering the air tunnel 20 or clogging the apertures or second end 28.

In particular embodiments, the first end 26 is placed proximate an aperture formed in a wall of food storage bin 8. For example, first end 26 may be coupled to a manifold 34 and the manifold may be coupled to an inner or outer wall of food storage bin 8 via screws 36 or other attachment means. The first end 26 may have a shape that is similar to the shape of the corresponding aperture of the food storage bin 8. The first end 26 is configured to receive an airflow from a fan system. The first end 26 may receive the air directly from a fan unit 12 or via other means such as duct system 18. The airflow may travel from the first end 26 of air tunnel 20 towards the second end 28. As the airflow travels between the first end and second end, portions of the airflow may escape through the apertures 30 and 32 on the body of air tunnel 20 and travel away from the air tunnel. The remaining airflow may escape through the second end 28 if the second end is open or permeable (in some embodiments, second end 28 may be closed or a plug may be inserted in the second end 28).

Air tunnel 20 may comprise any suitable materials and have any suitable shape. For example, an air tunnel may comprise a plastic, metal, rubber, or other suitable material, and may have a cylindrical, rectangular parallelepiped, or other suitable shape. In particular embodiments, air tunnel 20 is a corrugated or smooth plastic pipe or rubber hose.

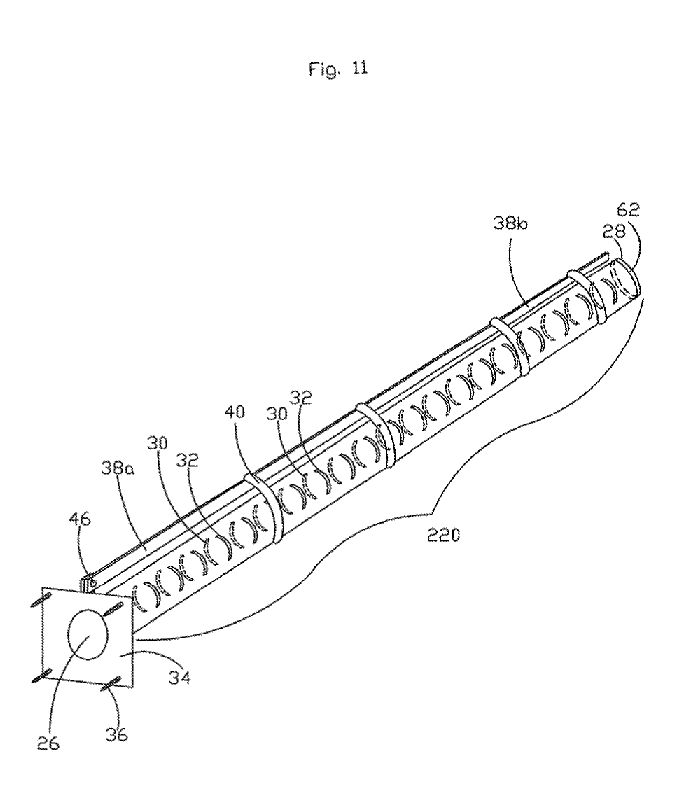

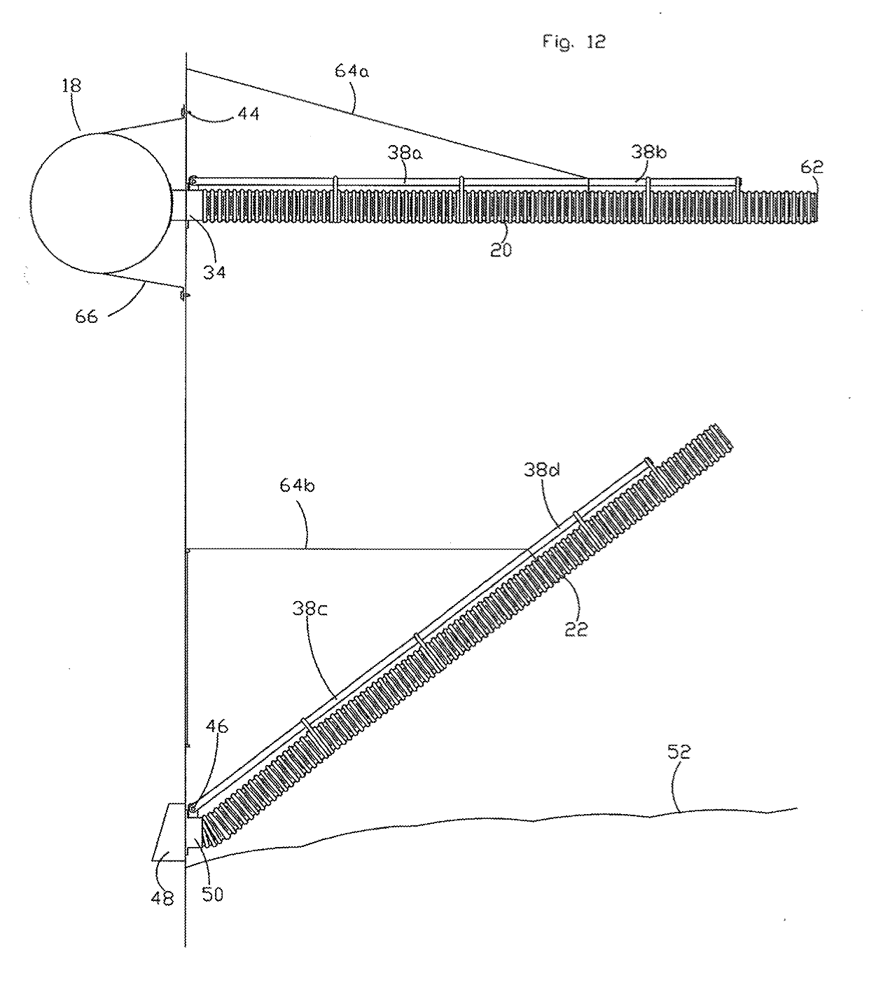

Air tunnel 20 may be flexible or rigid. If air tunnel 20 is flexible, air tunnel 20 may be coupled to one or more rigid support members 38 via one or more attaching bands 40. The rigid support members 38 may allow air tunnel 20 to maintain a generally consistent vertical height from the first end 26 to the second end 28 when air tunnel 20 is coupled to a wall of food storage bin 8 (i.e., the rigid support member reduces or eliminates droop of the air tunnel). Rigid support member 38 may comprise any suitable material and have any suitable shape. For example, rigid support member 38 may comprise steel, aluminum, other metal, or other suitable rigid material and may have a cylindrical, rectangular parallelepiped, or other suitable shape. In a particular embodiment, rigid support member 38 is a steel pipe or bar having a rectangular cross section. In the embodiment shown, air tunnel 20 is coupled to rigid support members 38a and 38b. Rigid support members 38a and 38b are coupled together via elastic band 42. Elastic band 42 allows support member 38b (and the portion of air tunnel 20 proximate support member 38b) to droop downward when support member 38b experiences downward pressure (e.g., pressure resulting from a food product being removed from food storage bin 8) and pulls support member 38b back into a generally horizontal position when the pressure is alleviated. The operation of elastic band 42 is illustrated in more detail in FIGS. 3 and 4. As described below with respect to FIGS. 11 and 12, air tunnels 20 or venting tunnels 22 or 24 may be implemented without elastic bands 42 in particular embodiments.

As indicated above, a venting tunnel 22 or 24 may have any suitable characteristics described in connection with air tunnel 20. For example, a venting tunnel may include any of the components illustrated in FIG. 2. Some of these components may serve different purposes in a venting tunnel. For example, an aperture or second end 28 of a venting tunnel may receive air that has traveled from an air tunnel 20 to the venting tunnel. This air may then travel through the body of the venting tunnel towards the first end 26 and may be released through the first end 26 to the outside of the food storage bin 8. As with the air tunnel 20, the first end 26 of a venting tunnel may be placed proximate an aperture formed in a wall of food storage bin 8. For example, first end 26 may be coupled to a manifold 34 and the manifold may be coupled to an inner or outer wall of food storage bin 8 via screws 36 or other attachment means. The first end may have a shape that is similar to the shape of the corresponding aperture of the food storage bin 8. In particular embodiments, the first end 26 may feed into a vent cover (e.g., vent cover 48 of FIG. 3) attached to the outside of the food storage bin or a portion of the venting tunnel. The vent cover may be designed to prevent rain, snow, or other moisture from entering the venting tunnel. The second end 28 of a venting tunnel may be closed, have a screen over the second end 28, or may be shaped in such a way as to prevent food product from entering the venting tunnel. In some embodiments, the one or more apertures have screens over them to block the food product.

FIG. 3 illustrates an example venting tunnel 22, example air tunnel 20, and example duct system 18, according to certain embodiments of the present disclosure. In the embodiment depicted, duct system 18 is coupled to an outside wall of food storage bin 8 via screws or other fastening devices 44. Duct system 18 may be coupled to food storage bin 8 via any suitable means. In the embodiment depicted, the outside wall of food storage bin 8 forms a wall of the duct system 18 and facilitates the operations of duct system 18 by preventing or limiting loss of the airflow during transport to the air tunnel system.

As depicted, air tunnel 20 maintains a generally consistent vertical height along its body due to the support provided by rigid support members 38. Venting tunnel 22 also includes rigid support members 38c and 38d. However, the rigid support member 38c is coupled to manifold 50 (which may include any suitable characteristics of manifold 34) via a hinge 46 that allows the venting tunnel to be angled upward. This operation may be useful when venting tunnel 22 is disposed near the base of food storage bin 8, since some food storage bins utilize a sweeping mechanism to collect and remove food product 52 located near the base of the food storage bin. Thus, in order to avoid contact with the sweeping mechanism, the venting tunnel 22 may be raised via hinge 46. When the sweeping mechanism is inactive or not present, venting tunnel 22 may be lowered back to a generally horizontal level. In particular embodiments, venting tunnels 22 may be attached to a wall of food storage bin 8 at a preferable height (e.g., one foot or more) to avoid interfering with the sweeping mechanism.

FIG. 4 illustrates the air tunnel 20 and venting tunnel 22 of FIG. 3 in the presence of food product 52 at a level that is higher than the air tunnel, according to certain embodiments of the present disclosure. FIG. 4 illustrates the operation of the rigid support members 38 and elastic bands 42 in allowing the inner portions of air tunnel 20 and venting tunnel 22 to flex downwards under pressure provided by food product 52. Such flexing may be necessary in order to avoid the fracturing of air tunnel 20 or venting tunnel 22 that would result from the pressure if the entire air tunnel 20 or venting tunnel 22 remained at the same vertical height.

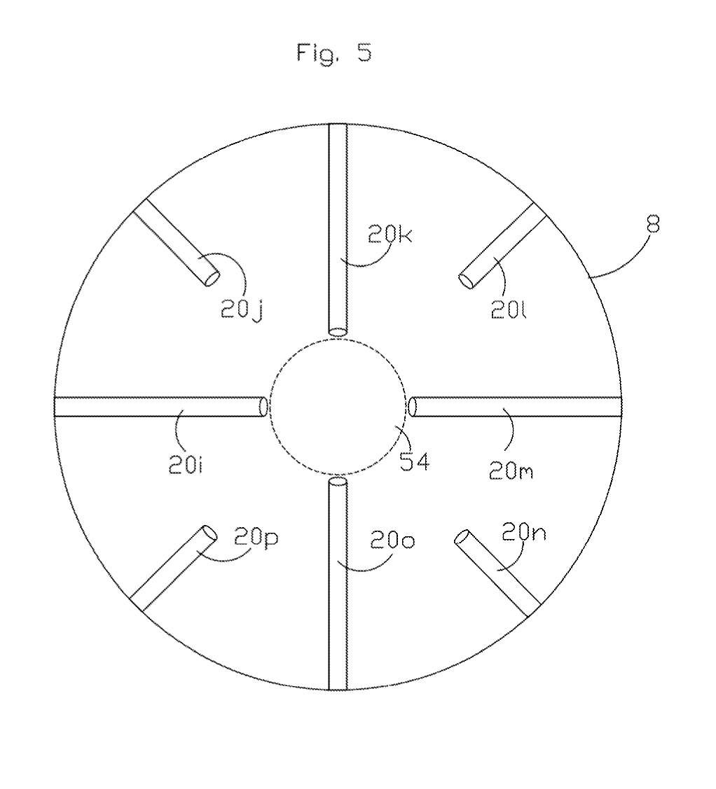

FIG. 5 illustrates an overhead view of an example air tunnel system, according to certain embodiments of the present disclosure. The air tunnel system depicted includes air tunnels 20i-20p. The air tunnels 20 each extend towards a central vertical axis of food storage bin 8 (i.e., the center point of circle 54). In the embodiment depicted, the lengths of the air tunnels are staggered to maintain a generally consistent distance between the ends of the air tunnels. In the embodiment depicted, every other air tunnel 20 has similar or equal lengths. For example, air tunnels 20i, 20k, 20m, and 20o each have a first length that is greater than a second length of air tunnels 20j, 20l, 20n, and 20p. Thus, an air tunnel 20j may be shorter than its adjacent air tunnels 20i and 20k, while an air tunnel 20i is longer than its adjacent air tunnels 20j and 20p. The air tunnels 20 may be staggered in any suitable manner and need not include sets of air tunnels that have equal lengths.

Such embodiments may results in increased drying efficiency due the air exiting air tunnels 20 being more evenly dispersed throughout food storage bin 8 than an air tunnel system in which all air tunnels 20 are the same length. Such embodiments also avoid overdrying of the food product near the central vertical axis of food storage bin 8. The embodiment depicted also results in a central portion of the food storage bin (i.e., circle 54) being void of air tunnels. This may ensure that the food product is unimpeded as it is removed from a floor center of food storage bin 8. For example, food storage bins often include an auger located in the middle of the base of the food storage bin that draws the food product downward during removal of the food product. The downward pressure exerted in the middle of the food storage bin 8 can be tremendous. Thus, embodiments in which a central portion of food storage bin 8 is void of air tunnels 20 may protect the air tunnels from breaking during removal of the food product. The central portion that is void of air tunnels may be (but is not limited to) a circle having a diameter of between three feet and six feet. This circle may have the same general height as the air tunnels 20 of the air tunnel system.

The configuration of air tunnel systems depicted herein are merely for illustrative purposes. Any suitable configuration operable to achieve reasonable air distribution in food storage bin 8 may be used. For example, an air tunnel system may comprise a plurality of air tunnels 20 that run parallel to each other across the food storage bin 8 in a horizontal plane. As another example, an air tunnel system could form a crisscross pattern in a horizontal plane.

A venting tunnel system may have any suitable configuration, such as any of those described herein in connection to an air tunnel system. In a particular embodiment, a venting tunnel system may be designed to be complementary to an air tunnel system, so as to increase the horizontal circulation of air as it travels between the systems. For example, if the configuration shown in FIG. 5 is used for an air tunnel system, a venting tunnel system placed below or above the air tunnel system may utilize the same configuration rotated by any suitable number of degrees. For example, for a venting tunnel system placed below an air tunnel system, the venting tunnel system may utilize the configuration of FIG. 5 rotated 45 degrees such that a short venting tunnel would be placed underneath a long air tunnel and vice versa.

FIG. 6 illustrates another example system 100 for drying a food product stored in a food storage bin 90, according to certain embodiments of the present disclosure. Food storage bin 90 is illustrated as having a height that is greater than the height of food storage bin 8, but may otherwise have any suitable characteristics described herein in connection with food storage bin 8. System 100 includes a first air tunnel system comprising air tunnels 120 and a second air tunnel system comprising air tunnels 220. Air tunnels 120 and 220 may have any suitable characteristics described herein in connection with air tunnels 20. The air tunnel systems are located at different heights. System 100 also includes a first venting tunnel system comprising venting tunnels 122, a second venting tunnel system comprising venting tunnels 222, and a third venting tunnel system comprising venting tunnels 24. The venting tunnel systems are located at different heights. Venting tunnels 122 and 222 may have any suitable characteristics described herein in connection with venting tunnels 22. Air tunnels 120 receive air from fan units 12a and 12b and release the air inside of food storage bin 90. Air tunnels 220 receive air from fan units 12c and 12d and release the air inside of food storage bin 90. Air released into food storage bin 90 by air tunnels 120 may travel through the food product and out of the food storage bin 90 via venting tunnels 122 and 222. Similarly, air released into food storage bin by air tunnels 220 may travel through the food product and out of the food storage bin 90 via venting tunnels 222 and 24. Other embodiments may include any suitable number of air tunnel systems each having a venting tunnel system above and below the respective air tunnel system. Such embodiments may enable the use of natural air drying in food storage bins for which it was previously not possible to use natural air drying due to the size of the fans that would be required.

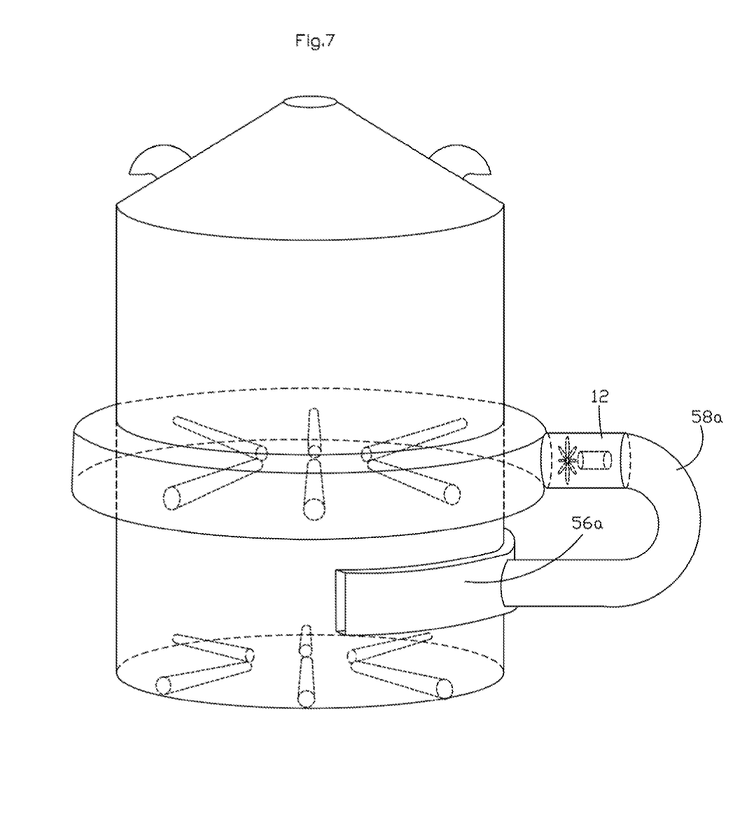

FIG. 7 illustrates an example air heating system, according to certain embodiments of the present disclosure. The air heating system may include a heat collector 56a and air duct 58a. Heat collector 56a is configured to convert energy received from sunlight into heat. The air around and inside of heat collector 56a may have a temperature that is greater than the ambient outside air. Air duct 58b may be located inside of or near heat collector 56a and configured to draw the heated air into fan unit 12. Thus, in this embodiment, the temperature of air supplied to an air tunnel system by fan unit 12 is greater than the temperature of the ambient air.

Air may be drawn into heat collector 56a through the bottom or sides of heat collector 56a. For example, heat collector 56a may comprise a hollow enclosure with one or more open faces, such as one or more sides, the bottom, or the top. In other embodiments, heat collector 56a may comprise a hollow enclosure with no open faces but with apertures in one or more of the faces. Heat collector 56a may comprise a heat absorbing material (e.g., metal or plastic), may have a heat absorbing color, may include reflectors, or have other suitable characteristics designed to improve the absorption of heat and the dissemination of that heat to the air surrounding heat collector 56a. In a particular embodiment, heat collector 56a comprises dark-colored sheet metal. Heat collector 56a may be located in any suitable location. For example, heat collector 56a may be mounted to a side or roof of food storage bin 8 or away from the food storage bin. The heat collector 56a may be in a fixed location or may be movable to allow the heat collector 56a to be placed in a preferable position in regards to sun, wind, or other considerations. In a particular embodiment, at least a portion of heat collector 56a is placed on the South side of food storage bin 8 to maximize heat collection.

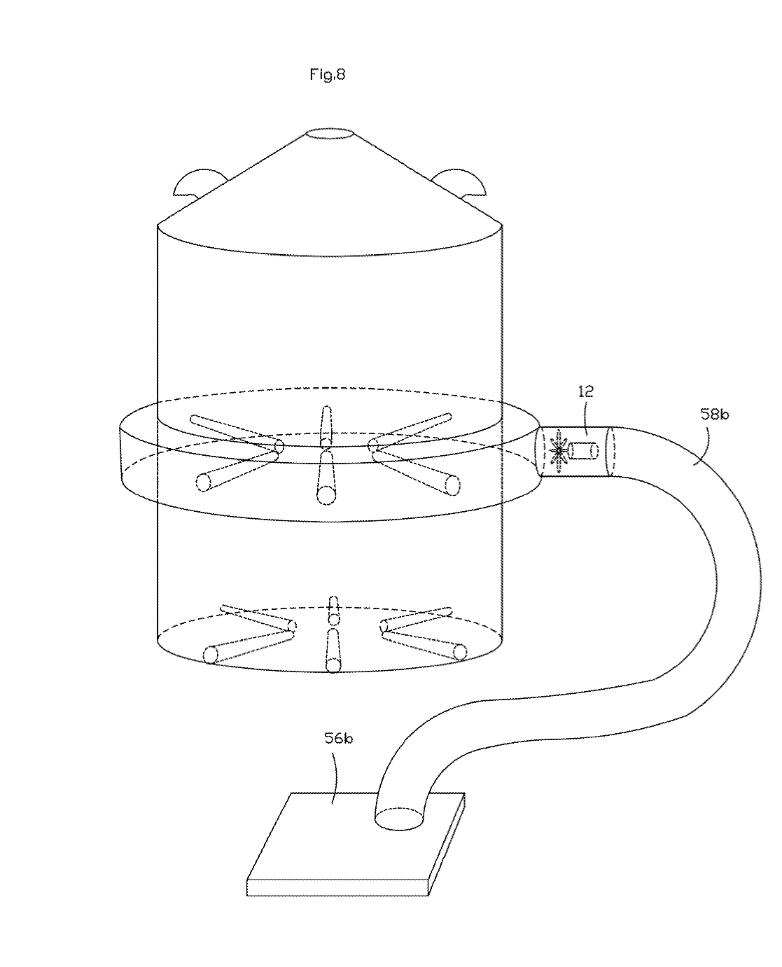

FIG. 8 illustrates an example air heating system, according to certain embodiments of the present disclosure. The air heating system may include a heat collector 56b and air duct 58b. Heat collector 56b is configured to convert energy received from sunlight into heat. The air around and inside of heat collector 56b may have a temperature that is greater than the ambient outside air. Air duct 58b may be located inside of or near heat collector 56b and configured to draw the heated air into fan unit 12. Thus, in this embodiment, the temperature of air supplied to an air tunnel system by fan unit 12 is greater than the temperature of the ambient air.

Air may be drawn into heat collector 56b through the bottom or sides of heat collector 56b. For example, heat collector 56b may comprise a hollow enclosure with one or more open faces, such as one or more sides, the bottom, or the top. In other embodiments, heat collector 56b may comprise a hollow enclosure with no open faces but with apertures in one or more of the faces. In particular embodiments, heat collector 56b may include one or more legs that elevate heat collector 56b above the ground. Heat collector 56b may comprise a heat absorbing material (e.g., metal or plastic), may have a heat absorbing color, may include reflectors, or have other suitable characteristics designed to improve the absorption of heat and the dissemination of that heat to the air surrounding heat collector 56b. In a particular embodiment, heat collector 56b comprises dark-colored sheet metal or a tarp. Heat collector 56b may be located near the base of food storage bin 8. The heat collector 56a may be placed in a fixed location or may be movable to allow the heat collector 56b to be placed in a preferable position in regards to sun, wind, or other considerations. In a particular embodiment, at least a portion of heat collector 56b is placed on the South side of food storage bin 8 to maximize heat collection.

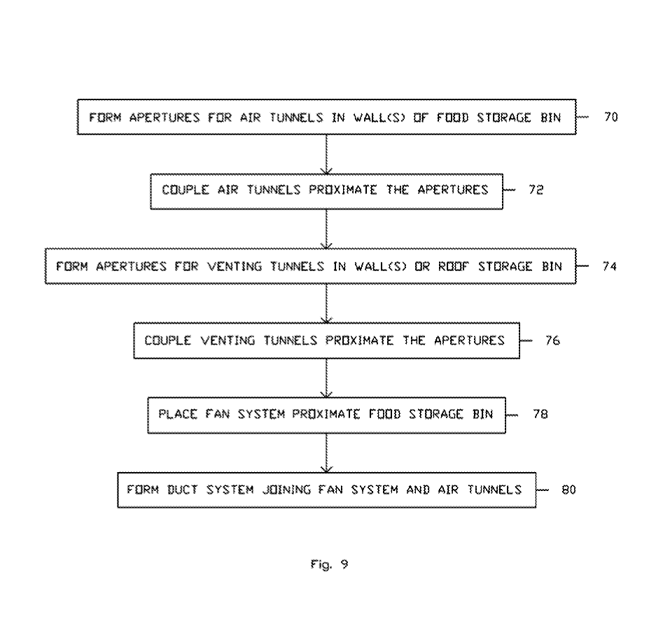

FIG. 9 illustrates an example method for forming a food product drying system. The method begins at step 70, where apertures for air tunnels 20 are formed in one or more walls of food storage bin 8. When a food storage bin 8 is retrofit to include one or more air tunnels 20, the apertures may be cut or otherwise formed in a wall of an existing food storage bin. When a food storage bin 8 is built in anticipation of having air tunnels 20, the wall of food storage bin 8 may be manufactured with the aperture or may be manufactured and the aperture may then be cut from the material of the wall or formed in another suitable manner. At step 72, air tunnels are coupled to food storage bin 8 proximate the apertures. In particular embodiments, air tunnels 20 are attached to an inside or outside of a wall of food storage bin 8 and may encompass or be encompassed by the corresponding apertures in the wall of food storage bin 8. The apertures formed in step 70 may be formed in the shape of the cross section of the corresponding air tunnel 20 or other suitable shape.

At step 74, apertures for venting tunnels 22 and 24 are formed in one or more walls or a roof of food storage bin 8. When a food storage bin 8 is retrofit to include one or more venting tunnels 22 or 24, the apertures may be cut or otherwise formed in a wall or roof of an existing food storage bin 8. When a food storage bin 8 is built in anticipation of having venting tunnels 22 or 24, the wall of food storage bin 8 may be manufactured with the aperture or may be manufactured and the aperture may then be cut from the material of the wall or formed in another suitable manner. At step 76, venting tunnels 22 and 24 are coupled to food storage bin 8 proximate the apertures. In particular embodiments, venting tunnels 22 and 24 are attached to an inside or outside of a wall or roof of food storage bin 8 and may encompass or be encompassed by the corresponding apertures in the wall or roof of food storage bin 8. The apertures formed in step 74 may be formed in the shape of the cross section of the corresponding venting tunnel 22 or 24 or other suitable shape.

At step 78, a fan system is placed proximate the food storage bin 8. In particular embodiments depicted, the fan system is attached to food storage bin 8 at the same vertical level as the air tunnel system to which it supplies air. In other embodiments, the fan system may be located at a different elevation from the corresponding air tunnel system (e.g., the fan system may be located at or near ground level). At step 80, a duct system 18 joining the fan system and air tunnels is formed and the method ends. In particular embodiments, duct system 18 (or a portion thereof) may be secured to a wall or roof of food storage bin 8.

Modifications, additions, or omissions may be made to the method without departing from the scope of the disclosure. The method may include more, fewer, or other steps. Additionally, steps may be performed in any suitable order.

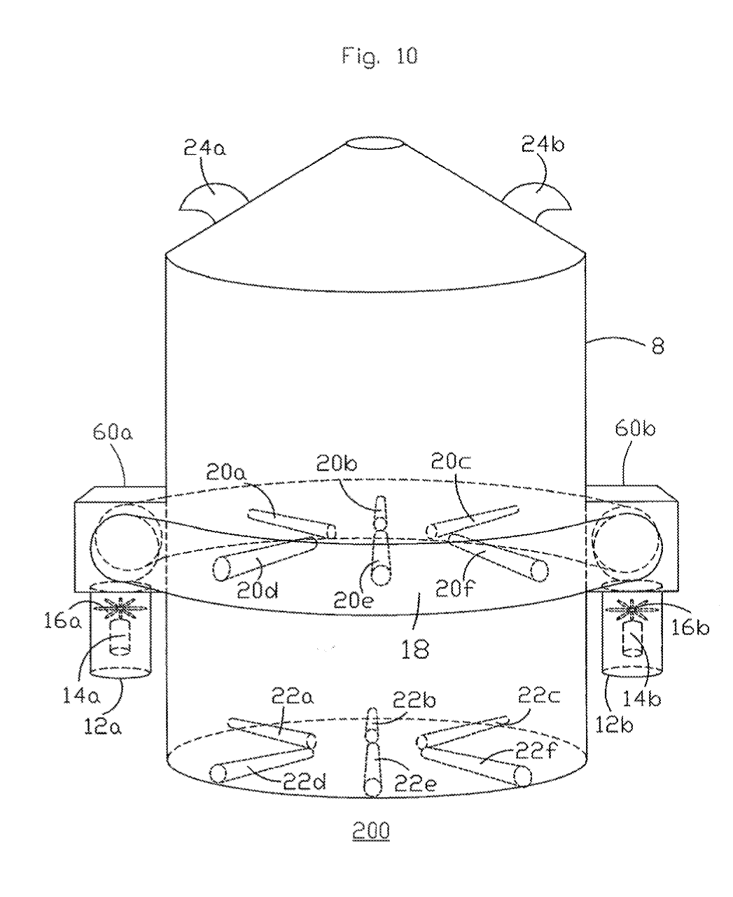

FIG. 10 illustrates an example system 200 for drying a food product stored in a food storage bin, according to certain embodiments of the present disclosure. System 200 includes many of the components illustrated in system 10 of FIG. 1, but illustrates a different configuration of the fan units 12 and duct system 18. In system 200, the fan units 12 are vertically oriented, such that blade set 16a is configured to blow air upward towards duct mount 60a and blade set 16b is configured to blow air upward towards duct mount 60b. Each duct mount 60 is coupled to the side of food storage bin 8 and may include a cavity through which air from a blade set 16 may flow into a cavity in duct system 18. In the embodiment depicted, this cavity begins on the underside of the duct mount 60, though this cavity may be located at any suitable location. For example, if fan unit 12 were placed on top of duct mount 60 or on the side of duct mount 60a, this cavity could begin at the top of duct mount 60 or the appropriate side of duct mount 60. Each duct mount 60 may also include a cavity through which duct system 18 may be placed. In the embodiment depicted, this cavity is shown as a tubular cavity running horizontally through duct mount 60. In operation, blade set 16a blows air upward through duct mount 60a and into the portion of duct system 18 located within duct mount 60a. Additional air from blade set 16a pushes the air through the duct system 18 around the circumference of food storage bin 8. Air moves from blade set 16b through duct system 18 in a similar manner. Fan units 12 may be attached to duct mount 60 at any suitable orientation. For example, fan unit 12a may be placed directly above duct mount 60a, horizontal to duct mount 60a, or at an angle to duct mount 60a. Although duct mount 60 is shown as having a cubical shape, any suitable shape may be used.

FIG. 11 illustrates an example air tunnel 220, according to certain embodiments of the present disclosure. Air tunnel 220 may be used in any of the embodiments described herein in place of air tunnel 20. Air tunnel 220 may include any of the components described above with respect to air tunnel 20. In the embodiment depicted, air tunnel 220 includes a cap 62 placed over the second end 28 of air tunnel 220. The cap 62 may prevent air from escaping from the second end 28 of air tunnel 220. Such a cap may increase the pressure of the air escaping through apertures 30 and 32 resulting in faster drying of a food product placed within food storage bin 8. In the embodiment depicted, air tunnel 220 omits elastic band 42.

FIG. 12 illustrates an example venting tunnel 22, example air tunnel 20, and example duct system 18, according to certain embodiments of the present disclosure. In the embodiment depicted, duct system 18 is supported by strap 66. Strap 66 may secure duct system 18 to the outer wall of food storage bin 8. As depicted, a portion of strap 66 may contact at least a portion of the circumference or other exterior surface (if duct system 18 is not cylindrical) of duct system 18 and other portions of strap 66 may be coupled to the wall of food storage bin 8 at multiple locations by fasteners 44. System 10 may include multiple straps 66 that support duct system 18 at multiple locations along the exterior surface of food storage bin 8. Accordingly, in particular embodiments, duct system 18 may be supported by multiple straps 66 and by duct mounts 60 as depicted in FIG. 10. In other embodiments, straps 66 and duct system 18 may be located along the interior of food storage bin 8. Strap 66 may comprise any suitable material such as wire, nylon, cable, metal strapping, or other material operable to support duct system 18. Fastener 44 may be any suitable fastening means such as a bolt, screw, rivet, or other suitable means.

FIG. 12 also depicts supports 64a and 64b coupled to air tunnel 20 and vent tunnel 22 respectively. Support 64a helps support air tunnel 20 against the downward pressure that may be caused by a food product placed within food storage bin 8. Support 64b may be used to support venting tunnel 22 or help lift venting tunnel 22 during operation of the sweeping mechanism as described above in connection with FIG. 3. In particular embodiments, at least a portion of support 64b may be located outside of food storage bin 8 such that a user may safely manipulate the tension of support 64b from outside of food storage bin 8 to raise or lower vent tunnel 22. Supports 64a and 64b may include any suitable material, such as wire, nylon, cable, metal strapping, or other material operable to support air tunnels 20 or vent tunnels 22.

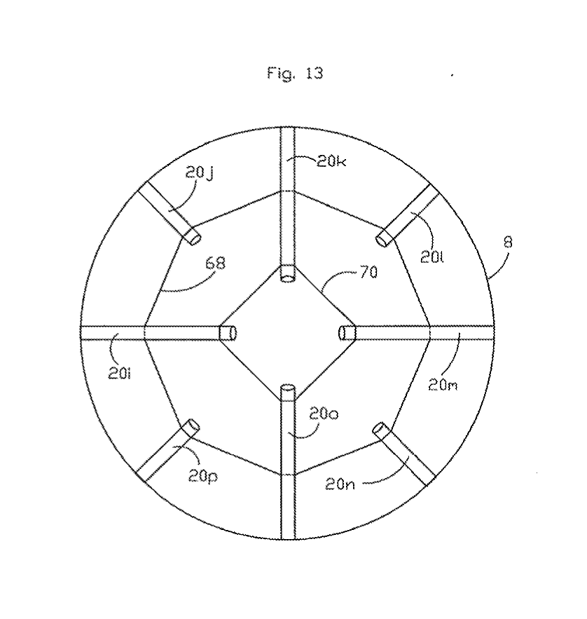

FIG. 13 illustrates an overhead view of an example air tunnel system, according to certain embodiments of the present disclosure. The air tunnel system depicted includes air tunnels 20i-20p. The air tunnels 20 each extend towards a central vertical axis of food storage bin 8. In the embodiment depicted, the lengths of the air tunnels are staggered to maintain a generally consistent distance between the ends of the air tunnels.

As food is removed from food storage bin 8, air tunnels 20 or venting tunnels 22 may be subject to lateral pressure that could displace and damage air tunnels 20. In particular embodiments, two or more of the air tunnels or venting tunnels are coupled together inside of food storage bin 8 to counteract this pressure. As an example, in the embodiment depicted, air tunnels 20i, 20k, 20m, and 20o are coupled together by support 70. As another example, air tunnels 20j, 20l, 20n, and 20p are coupled together by support 68. In particular embodiments, support 68 may also be coupled to air tunnels 20i, 20k, 20m, and 20o. Supports 68 and 70 may be fastened to air tunnels 20 in any suitable manner, such as any of the fastening methods described herein. Supports 68 and 70 may include any suitable materials such as wire, nylon, cable, metal strapping, or other material operable to support air tunnels 20. In particular embodiments, air tunnels 20 or venting tunnels 22 located at the floor level are not attached to each other because the floor of food storage bin 8 may provide the necessary support and the downward pressure is weaker at this level.

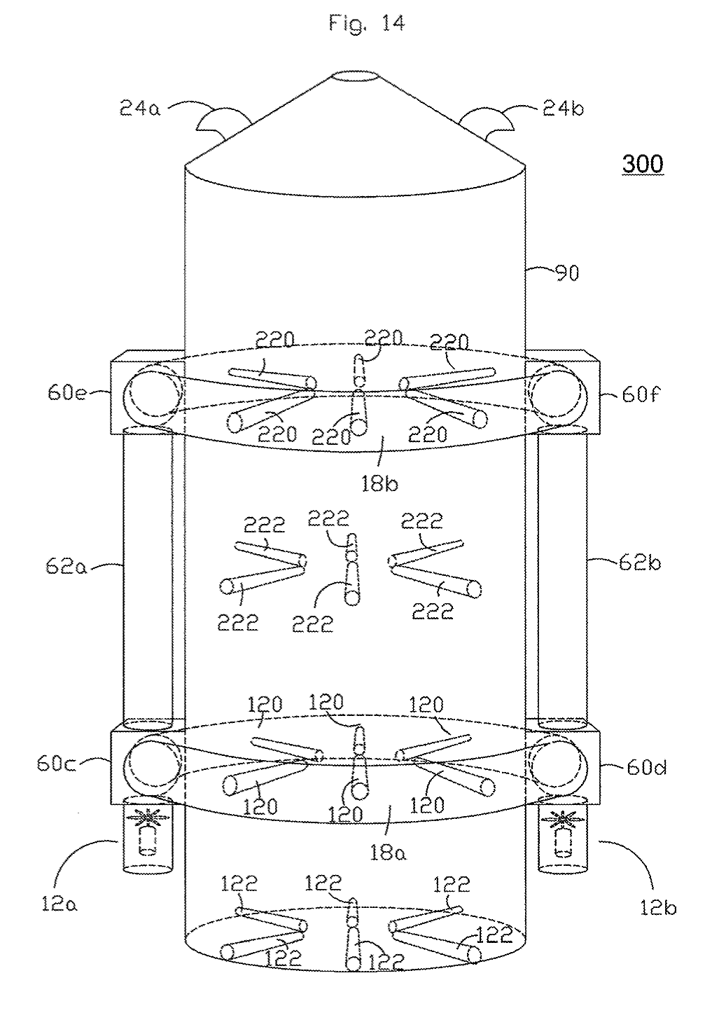

FIG. 14 illustrates another example system 300 for drying a food product stored in a food storage bin 90, according to certain embodiments of the present disclosure. System 300 may include any of the components of system 100 described above in connection with FIG. 6. In the embodiment depicted, system 300 includes duct system 62a disposed between duct mounts 60c and 60e and duct system 62b disposed between duct mounts 60d and 60f. Duct mount 60e may include a cavity through which air travelling upward from 62a may pass through and enter duct system 18b. Similarly, duct mount 60f may include a cavity through which air travelling from 62b may pass through and enter duct system 18b. In the embodiment depicted in FIG. 14, system 200 includes two fan units 12a and 12b for supplying air to multiple air tunnel systems (one air tunnel system comprising air tunnels 120 and one air tunnel system comprising air tunnels 220). For example, fan unit 12a may propel air in an upward direction. A portion of the air may flow through duct system 18a to air tunnels 120. Another portion of the air may be propelled upward through duct system 62a to duct system 18b and air tunnels 220. Fan unit 12b may operate in a similar manner. Such embodiments reduce the number of fan units 12 required to supply air to multiple air tunnel systems.

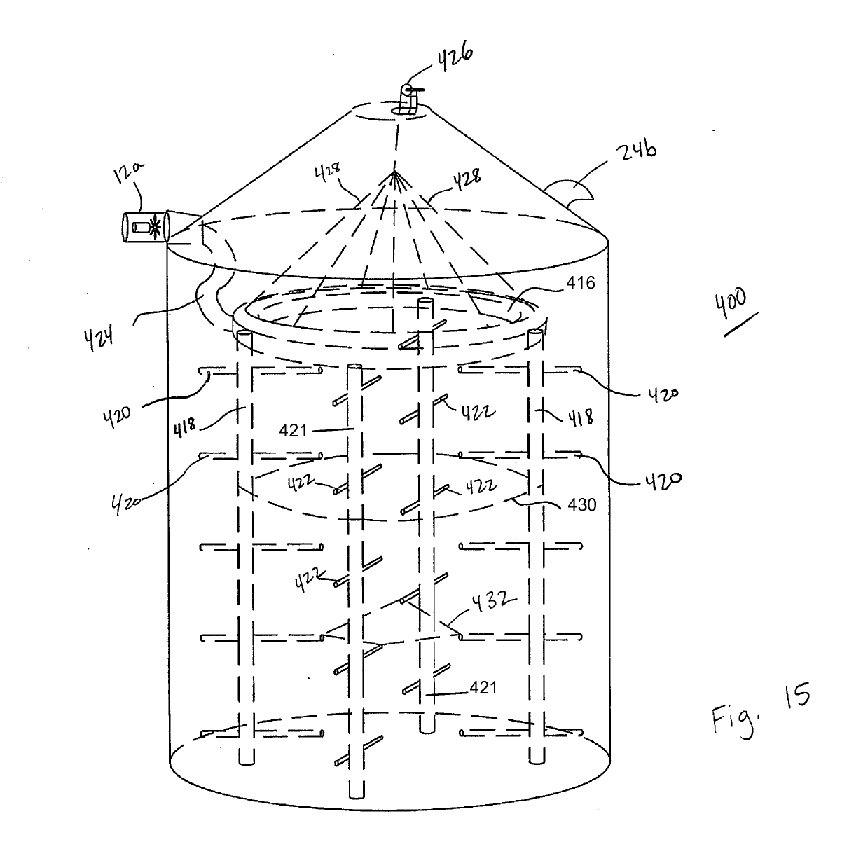

FIG. 15 illustrates another example system 400 for drying a food product stored in a food storage bin, according to certain embodiments of the present disclosure. The food storage bin of system 400 may have any of the characteristics of food storage bin 8 or food storage bin 90 as described herein. System 400 includes duct system 416 that is located inside of the food storage bin. Duct system 416 may have any of the characteristics of duct system 18 described herein. Duct system 416 may be coupled to the food storage bin in any suitable manner, either directly or indirectly and may have any suitable shape as described above. In the embodiment depicted, duct system 416 has an annular shape and is coupled to cables 428. As depicted, cables 428 couple to a central point at their apex and a cable runs from the apex to a winch 426. In other embodiments, one or more of the cables 428 may be coupled to any suitable points, such as other points of the roof or the upper wall of the food storage bin. Winch 426 is operable to lower or raise cables 428 (and anything attached to cables 428 such as duct system 416, air tunnels 418 or 420, or a venting tunnel system comprising venting tunnels 421 or 422). Winch 426 may be mounted at any suitable portion of the food storage bin, such as at or near the top of the bin.

In system 400, duct system 416 is configured to receive air from one or more fan units 12a (which may have any of the characteristics described herein with respect to other fan units 12). In the embodiment depicted, fan unit 12a is coupled to the outside of the food storage bin via a manifold attached to the roof or upper portion of the bin. Each fan unit may distribute air directly to duct system 416 or via an intermediary air tunnel such as flex duct 424. This air circulates through duct system 416 and into an air tunnel system comprising air tunnels 418 and 420 (which may have any of the characteristics of the other air tunnels described herein).

In particular embodiments, the air tunnel system (or a portion thereof) may be coupled to the food storage bin via intermediate components. For example, in the embodiment depicted, air tunnels 418 and 420 are coupled to the roof of the food storage bin through duct system 416, cables 428, and winch, 426. In various embodiments, in order to receive air from duct system 416, air tunnels 418 are coupled to duct system 416. For example, the air tunnels 418 may be inserted directly into one of the sides of duct system 416 (e.g., the underside) and receive air pressure from the duct system 416. In the embodiment depicted, air tunnels 418 are generally vertically disposed (though they may be disposed at any suitable angle) and air from the duct system 416 flows downward through the air tunnels 418. In various embodiments, air tunnels 418 may be perforated to allow a portion of the air to escape from air tunnels 418 into surrounding food product placed in the bin. Air tunnels 418 are operable to direct the air downward and into other air tunnels 420 that are coupled to air tunnels 418. In the embodiment depicted, air tunnels 418 are generally horizontally disposed (though they may be disposed at any suitable angle). Air may be dispersed from perforations or other openings of air tunnels 418 into a food product stored in the food storage bin.

In particular embodiments, as the air is exhausted out of an air tunnel 420, the air travels horizontally toward the venting tunnels 422 located on either side of the air tunnel 420. In particular embodiments, the venting tunnels 422 are staggered at different heights so that the air will travel sideways and upward and downward from the air tunnels 420 to the venting tunnels 422. For example, one venting tunnel 421 may have venting tunnels 422 attached at various heights while another venting tunnel 421 may have attached venting tunnels 422 that are at different heights. This configuration will allow for greater coverage of airflow through the food product.

At least a portion of the air dispersed by air tunnels 418 and/or 420 may pass through a food product and then be collected by venting tunnels 421 and/or 422 and transported out of the bin via any suitable means, such as those described above with respect to other venting tunnels. For example, the air may be transported towards the top of the bin and exit through venting tunnel 24b. As another example, one or more venting tunnels 421 and/or 422 may interface with a wall or roof of the food storage bin and vent air directly to the outside of food storage bin. In particular embodiments such as the one depicted, venting tunnels 421 are configured to be raised or lowered. For example, venting tunnels 421 may be coupled to the outside of duct system 416 such that they may be raised or lowered when duct system 416 is raised or lowered. As another example, venting tunnels 421 may be coupled to the same apparatus (e.g., winch 426) that raises and lowers duct system 416 or an independent apparatus that raises or lowers venting tunnels 421. Despite any such coupling, venting tunnels 421 do not provide air back into duct system 416 as this would reduce the drying capabilities of the air flowing through air tunnels 418 and 420 since the air from the venting tunnels 421 generally contains increased moisture relative to ambient air from outside of the food storage bin.

In a particular embodiment, air tunnels 418 (and attached air tunnels 420) and venting tunnels 421 (and attached venting tunnels 422) are all suspended from duct system 416. For example, the venting tunnels 421 may hang from and below or to the side of the duct and may be exhausted into a void at the top of the bin or additional ducting out the roof or side of the bin. In operation, duct system 416, air tunnels 418 and venting tunnels 421 may be raised to (or close to) their highest level prior to filling the food storage bin with food product by operation of winch 426 (or other raising means). After the food storage bin is filled with food product, the upward tension provided by the winch or other means is released. The duct system 416, the air tunnels 418, and the venting tunnels 421 will remain at the same level, supported by the food product. Over time, as the food product dries and shrinks, the duct system 416 and tunnels 418 and 421 will sink with the corn. In the absence of such a system, the downward pull exerted by the shrinking food product may cause breakage or distortion of duct system 416 and tunnels 418.

System 400 may also include one or more cables 430 surrounding the air tunnels 418 and venting tunnels 421. When the food storage bin is being filled with food product, the food product generally drops down from the center of the bin and piles up in the form of an inverted cone. There is constant downward and outward pressure from the piling up of the food product. Cable(s) 430 may act to stabilize tunnels 418 and tunnels 421 against such force. System 400 may also include one or more cables 432 connecting two or more air tunnels 422 and/or venting tunnels 422 that are located on or about the same level. Cables 432 may also act to stabilize these air tunnels against forces induced by the filling of food storage bin with food product.

In various embodiments, any suitable number of components may be used to implement system 400. For example, additional fan units 12a may feed into one or more duct systems 416. As another example, system 400 may include more or less air tunnels 418 or 420 or venting tunnels 421 and 422. The number of other components may be varied as well.

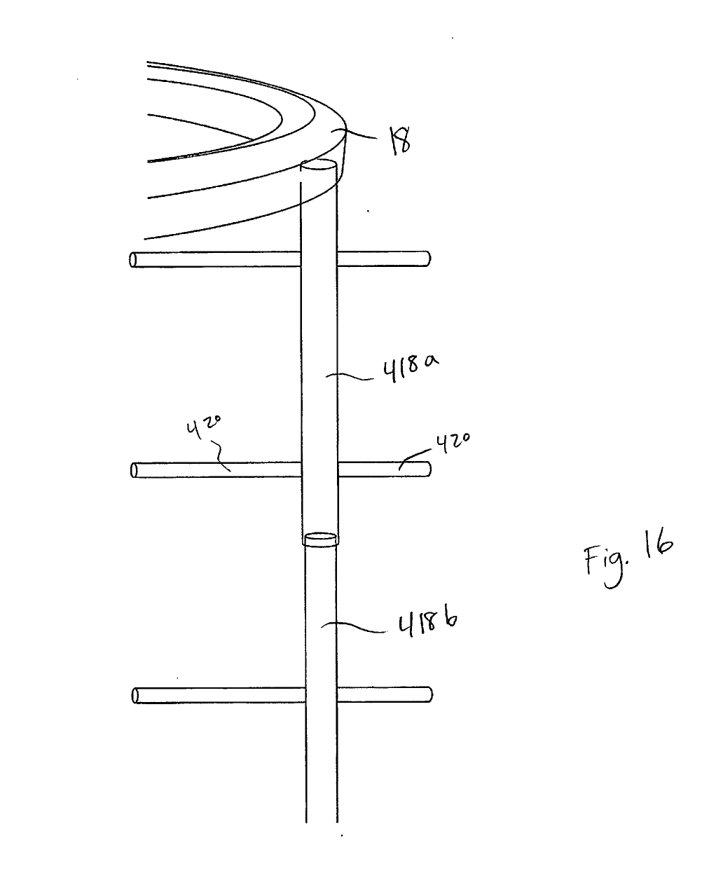

FIG. 16 illustrates an embodiment including multiple segments 418a and 418b of an air tunnel 418, according to certain embodiments of the present disclosure. In this embodiment, segment 418a is a tube that partially houses one end of a smaller tube of segment 418b. In various embodiments, such sliding joints may be present on air tunnels 418 and/or venting tunnels 421. When the tunnels are raised to their highest level, the sliding joints are fully extended. As the food product shrinks, there is greater movement downward in the top area of the food product than at the bottom. As the food product shrinks, the sliding joints allow for the air tunnels to move downward with the food product. For example, when a downward force is exerted on segment 418b, segment 418a may slide down such that a larger portion of segment 418b is housed within segment 418a, effectively allowing the height of the air tunnel 418 to contract as the food product pulls the air tunnel 418 downward.

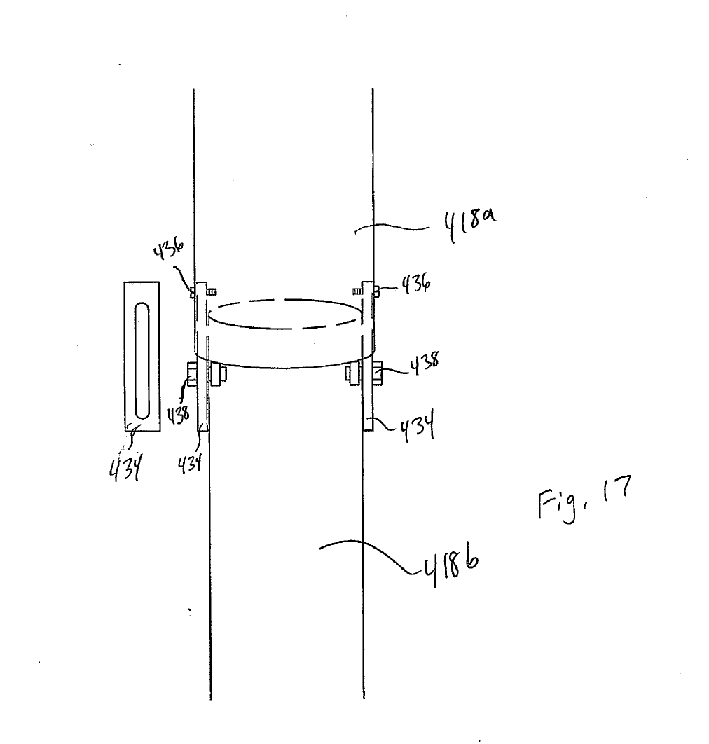

FIG. 17 illustrates an example sliding joint that may be used with air tunnels 418 or venting tunnels 421, according to certain embodiments of the present disclosure. In a particular embodiment, the sliding joint may comprise a pair of plates 434 having an aperture therein. A first portion of plate 434 may be disposed on the inside of segment 418a and a second end of plate 434 is disposed on the outside of segment 418b. The plate may be attached via bolts or screws 436 and 438 or by other suitable means. As the upper segment 418a experiences a downward force, the upper segment 418a may slide over a larger portion of lower segment 418b until equilibrium is reached. The bolts or screws 438 may operate to constrain the range of movement of upper segment 418a with respect to lower segment 418b.

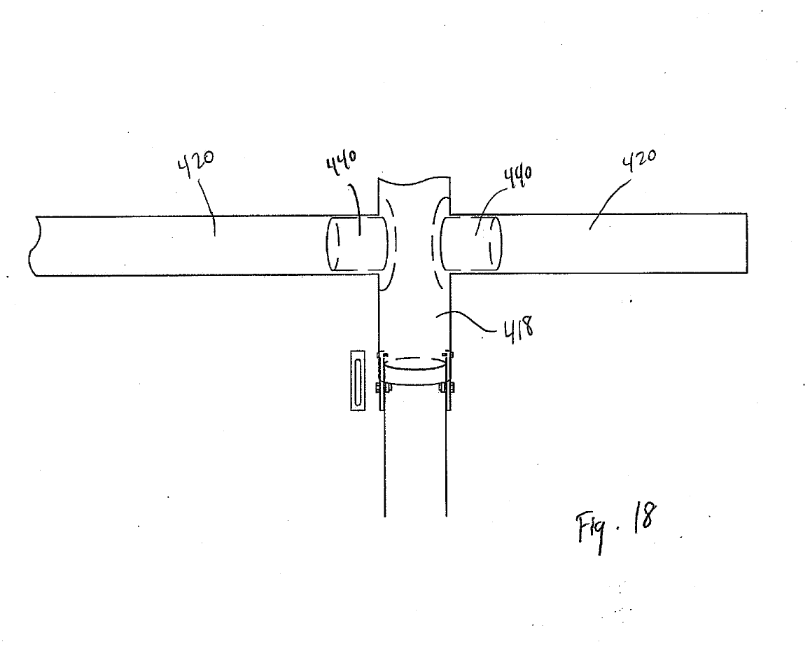

FIG. 18 illustrates a portion of an example air tunnel 418 and example air tunnels 420 attached thereto, according to certain embodiments of the present disclosure. Air tunnels 420 may be attached to air tunnel 418 in any suitable fashion, such as mechanical fasteners, glue, or other means. In the embodiment depicted, short appendages 440 are attached to air tunnel 418 and air tunnels 420 are placed over the appendages 440. The appendages are configured to allow air to pass from air tunnel 418 into air tunnels 420 and to provide vertical support for air tunnels 420. Other suitable attachment means or orientations may be used.

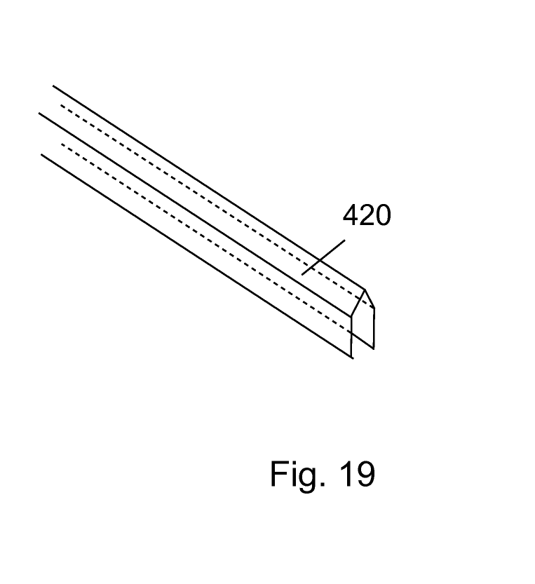

FIG. 19 illustrates a portion of example air tunnel 420, according to certain embodiments of the present disclosure. In the example of FIG. 19, air tunnel 420 includes 4 solid faces and an aperture running along the entire bottom of the air tunnel 420. In this embodiment, airflow along the length of air tunnel 420 may be constrained by four solid faces while escape of the airflow into the food product may be allowed by the open bottom of the air tunnel 420. Such embodiments may result in increased airflow away from the air tunnel 420 in relation to an embodiment that includes a generally closed air tunnel 420 with smaller apertures such as slits.

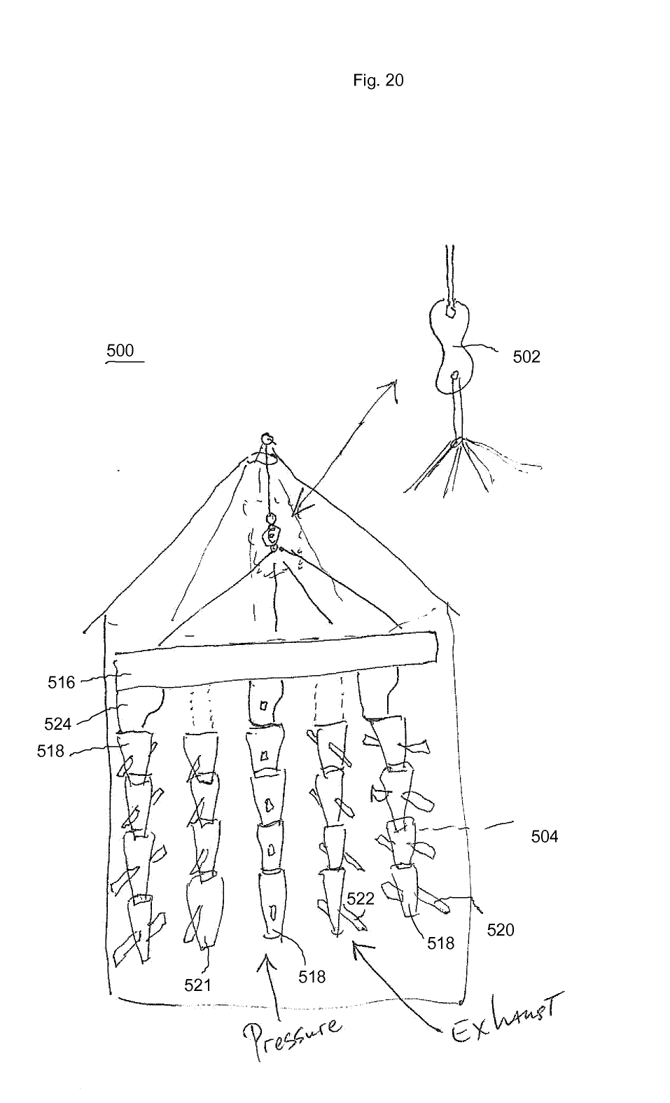

FIG. 20 illustrates another example system 500 for drying a food product stored in a food storage bin, according to certain embodiments of the present disclosure. System 500 and its components may have any suitable characteristics described herein with respect to system 400 and its components. System 500 includes duct system 516 that is located inside of the food storage bin. Duct system 516 may have any of the characteristics of duct system 18 or duct system 416 described herein. Duct system 516 may be coupled to the food storage bin in any suitable manner, either directly or indirectly and may have any suitable shape as described above. In the embodiment depicted, duct system 516 has an annular shape and is coupled to cables or other supports that are suspended from a stretchable link 502, which is in turn coupled to a winch at or near an apex of the food storage bin. In some situations, the filing of the food storage bin may take several days. During this time, the food product continually settles and pulls down on the air tunnels and venting tunnels. Stretchable link 502 allows the duct system 516 and components attached to the duct system to rise and fall as needed in order to avoid breakage of the components. Stretchable link 502 may be constructed of any strong, stretchable material such as rubber or the like. Alternatively, stretchable link could also comprise a gas, air or hydraulic cylinder, or the like.

Duct system 516 is configured to receive air from one or more fan units (which may have any of the characteristics described herein with respect to fan units 12). This air circulates through duct system 516 and into an air tunnel system comprising air tunnels 518 and 520 (which may have any of the characteristics of the other air tunnels described herein) via air boots 524. Air boot may have any suitable shape. In the embodiment depicted, one end of air boot 524 is wider than the other end, while the body of the air boot has a gradual slope from the wider end to the narrower end. At least a portion of the air dispersed by air tunnels 518 and/or 520 may pass through a food product and then be collected by venting tunnels 521 and/or 522 (which may have any of the characteristics of the other venting tunnels described herein) and transported out of the bin via any suitable means, such as those described above with respect to other venting tunnels.

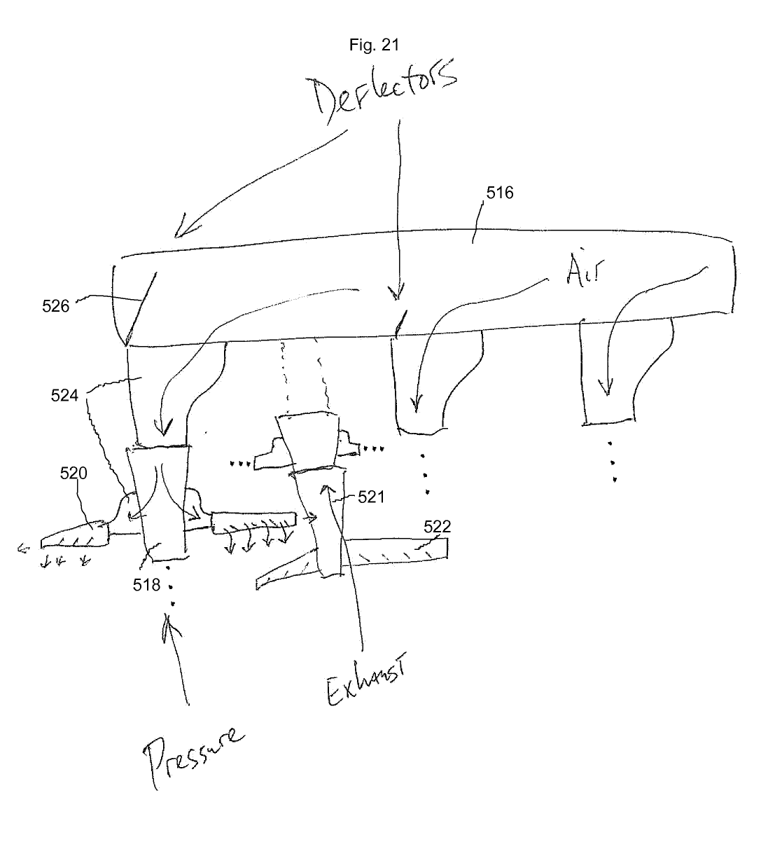

FIG. 21 illustrates various components of system 500. As depicted, air boots 524 provide a transition from the duct system 516 to air tunnels 518 and also a transition from the air tunnels 518 to the air tunnels 520. The air boots allow for a gentler, more efficient airflow as compared to immediate 90 degree tees between components of the system. Deflectors 526 may be placed proximate one end of the air boots 526 attached to the duct system 516. Deflectors may have any suitable shape, and in one embodiment are rectangular sheets. As the velocity and pressure in the duct system decreases between fan locations, longer and more aggressive deflectors may be placed in the air boots 524 to keep the available air at a constant in the air boots 524 and air tunnels 518. Air boots 524 may be similarly placed at the intersections of venting tunnels 521 and 522 and venting tunnels 521 and the duct system 516 to provide more efficient air travel.

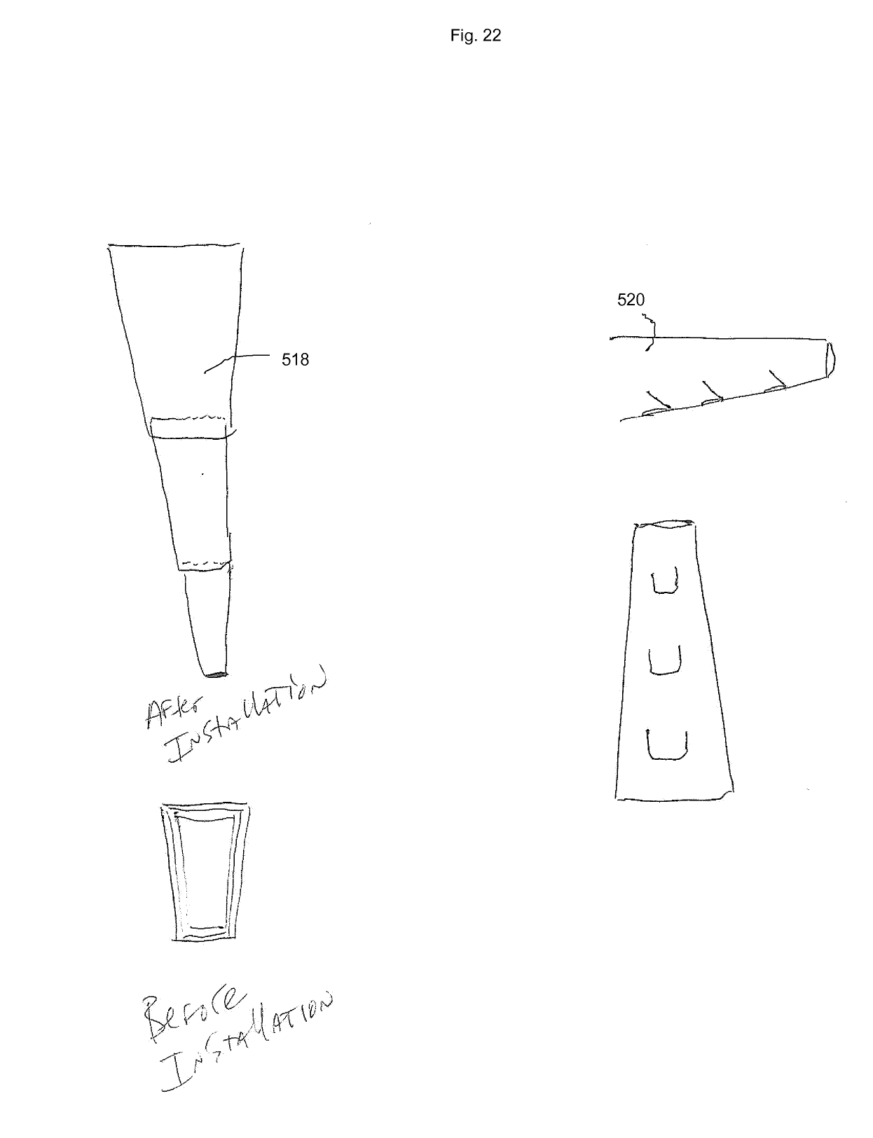

FIG. 22 illustrates various components of system 500. As depicted, air tunnels 518 may have a truncated conical shape to provide telescoping ability to reduce the amount of weight and space of the air tunnel system. This may ease shipping and installation burdens. The further an air tunnel 518 is from duct system 516, the less air capacity is needed to service the air tunnels 520 that are attached to the air tunnel 518, and thus the diameters of the air tunnels may monotonically decrease in size from the top of the air tunnel system to the bottom. Air tunnels 520 may have similar characteristics and advantages. During manufacture, U shaped cuts may be made in the air tunnels 518 or 520. For shipment, air tunnels may be placed inside of other air tunnels to reduce shipping size. At installation, the tubes are separated and the U shaped tabs are bent inward and become deflectors that are at least partially perpendicular to airflow in order to force the air out of the air tunnel in a more aggressive fashion than a simple slit would provide.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

As described, various embodiments of the present disclosure may enable improved drying of food products. Modifications, additions, or omissions may be made to the systems and apparatuses disclosed herein without departing from the scope of the disclosure. The components of the systems and apparatuses may be integrated or separated. For example, one or more objects may be combined and/or the functions of one or more objects may be performed by another object. Moreover, the operations of the systems and apparatuses may be performed by more, fewer, or other components.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims. For example, any of the embodiments depicted may be used with one or more portions of the other embodiments depicted. As one example, air tunnels 20, 120, 220, 418, 420, 518, and 520 may be interchangeable with each other or with venting tunnels 22, 24, 122, 222, 421, 422, 521, and 522 (which also may be interchangeable with each other), and any of these air tunnels or venting tunnels may include any of the characteristics described with respect to another air tunnel or venting tunnel. As another example, any of the systems described herein may utilize any of the duct systems 18, 62, 416, or 516.

I claim:

1. A system comprising:
an air tunnel system coupled to a food storage bin having a circular cross section and a roof, the air tunnel system comprising a plurality of air tunnels, each air tunnel of the air tunnel system comprising:
a first end operable to receive an airflow from a fan system comprising at least one fan;
a body operable to direct the airflow from the first end of the air tunnel towards a second end of the air tunnel; and
at least one aperture formed in the body between the first end and the second end, the at least one aperture operable to direct the airflow away from the body of the air tunnel;
a first venting tunnel system comprising a plurality of venting tunnels coupled to the food storage bin, at least a portion of the first venting tunnel system disposed below at least a portion of the air tunnel system, the first venting tunnel system operable to receive a first portion of the airflow from the air tunnel system and direct the first portion of the airflow outside of the food storage bin; and
a second venting tunnel system comprising a plurality of venting tunnels coupled to the food storage bin, at least a portion of the second venting tunnel system disposed above at least a portion of the air tunnel system, the second venting tunnel system operable to receive a second portion of the airflow from the air tunnel system and direct the second portion of the airflow outside of the food storage bin.

2. A system comprising:
a first air tunnel system configured to be coupled to a food storage bin, the first air tunnel system comprising one or more air tunnels, each air tunnel of the first air tunnel system comprising:
a first end operable to receive an airflow from a first fan system comprising at least one fan;
a body operable to direct the airflow from the first end of the air tunnel towards a second end of the air tunnel; and
at least one aperture formed in the body between the first end and the second end, the at least one aperture operable to direct the airflow away from the body of the air tunnel.

3. The system of claim 2, wherein the first air tunnel system is operable to direct a first portion of the airflow towards a roof of the food storage bin and a second portion of the airflow towards a floor of the food storage bin.

4. The system of claim 2, wherein the first air tunnel system is operable to reduce the moisture content of hydrated food products placed above and below at least a portion of the first air tunnel system.

5. The system of claim 2, wherein each air tunnel is flexible and is coupled to a rigid support member.

6. The system of claim 5, wherein each rigid support member of the second venting system is coupled to a hinge disposed proximate the wall of the food storage bin.

7. The system of claim 2, wherein each air tunnel is rigid.

8. The system of claim 2, wherein each air tunnel of the first air tunnel system comprises a corrugated pipe.

9. The system of claim 2, wherein each air tunnel of the first air tunnel system comprises a smooth pipe.

10. The system of claim 2, further comprising:
a first venting tunnel system configured to be coupled to the food storage bin below at least a portion of the first air tunnel system, the first venting tunnel system comprising one or more venting tunnels, each venting tunnel of the first venting tunnel system comprising:
a first end operable to exhaust air received by the venting tunnel from the first air tunnel system to the outside of the food storage bin;
a body operable to direct air received from the first air tunnel system towards the first end of the venting tunnel; and
at least one aperture formed in the body, the at least one aperture operable to receive air from the first air tunnel system.

11. The system of claim 10, further comprising a second venting tunnel system configured to be disposed above the first air tunnel system, the second venting tunnel system operable to receive air from the first air tunnel system and exhaust the air outside of the food storage bin.

12. The system of claim 2, the first air tunnel system comprising a plurality of air tunnels, wherein the first end of each air tunnel is coupled to the wall of the food storage bin and the body of each air tunnel extends towards a central vertical axis of the food storage bin.

13. The system of claim 2, wherein a first air tunnel and a second air tunnel of the first air tunnel system have substantially similar lengths and a third air tunnel of the first air tunnel system is disposed between the first air tunnel and the second air tunnel and has a length shorter than the lengths of the first air tunnel and second air tunnel.

14. The system of claim 10, further comprising a second air tunnel system configured to be coupled to the wall of the food storage bin, the second air tunnel system operable to direct air through the food storage bin towards the roof of the food storage bin and towards the floor of the food storage bin.

15. The system of claim 2, further comprising a duct system encompassing the food storage bin and operable to carry air from the first fan system to the at least one air tunnel of the first air tunnel system.

16. The system of claim 2, wherein the first air tunnel system is coupled to the wall of the food storage bin at a vertical height and a portion of the food storage bin having the same vertical height and located within a predetermined distance from the central vertical axis of the food storage bin is void of the air tunnel system.

17. The system of claim 2, wherein the at least one aperture of an air tunnel comprises a first plurality of slits formed on one side of the air tunnel and a second plurality of slits formed on an opposite side of the air tunnel.

18. The system of claim 2, further comprising:
a heat collector configured to heat air inside of the heat collector; and
an air duct configured to draw the heated air and transfer the heated air to the first fan system.

19. A system comprising:
a duct system configured to be disposed inside of a food storage bin;
an air tunnel system configured to be coupled to the duct system, the air tunnel system comprising one or more first air tunnels configured to carry air from the duct system to an elevation that is lower than the elevation of the duct system, the one or more first air tunnels each coupled to one or more second air tunnels, each second air tunnel comprising:
a first end operable to receive an airflow from a first fan system comprising at least one fan;
a body operable to direct the airflow from the first end of the air tunnel towards a second end of the air tunnel; and
at least one aperture formed in the body between the first end and the second end, the at least one aperture operable to direct the airflow away from the body of the air tunnel.
